(19) United States
(12) Patent Application Publication
(10) Pub. No.: US 2008/0283263 A1
(43) Pub. Date: Nov. 20, 2008

(54) AIR TOOL

(76) Inventor: Hsin Fa Kang, Tainan City (TW)

Correspondence Address: Kang Hsin Fa, P.O. Box 90, Tainan City, 70499, TW

(21) Appl. No.: 11/748,493

(22) Filed: May 15, 2007

(51) Int. Cl. B25D 9/00

(52) U.S. Cl. 173/200

(57) ABSTRACT

An air tool is composed of a main rod, a sleeve, a compression spring and a connector. The main rod possesses a plugging bar, a blocking annular surface, and a through bar having a connecting portion in its end portion. The through bar is mounted with the compression spring and inserted in the sleeve. The sleeve has a blocking annular surface to block the compression spring. The connector is screwed with the end of the main rod. In addition, via the elastic counterforce of the compression spring, the impact of the air tool generated while operating the air tool can be weakened so as to prevent the air tool from being damaged and enable a user to hold the air tool easily.

### BACKGROUND OF THE INVENTION

1. Field of the Invention

This invention relates to an air tool, particularly to one composed of a main rod, a sleeve, a compression spring and a connector. Via the elastic counterforce of the compression spring, the impact of the counterforce coming from the main rod while operating can be weakened to prevent the air tool from being damaged and let a user hold the air tool easily.

2. Description of the Prior Art

Commonly, as shown in FIG. 1, a conventional air tool (T1) includes an impacting member (T2) located at its front portion, an impacting hammer (T3) installed inside the impacting member (T2) to swiftly move back and forth while being driven by the air pressure, and a striking device (T4), such as a hammer or a chisel, assembled in front of the impacting member (T2) to carry out impacting by pressing a button (T11) to let air rush into the impacting member (T2) to push the impacting hammer (T3). However, the conventional air tool lacks for a buffer device, not only apt to damage the impacting hammer (T3) or the striking device (T4), but also enabling a user to hold the tool stably because of the vigorous counteractive vibration while operating.

Moreover, as shown in FIG. 2, a bearing (B) is placed in a shaft opening (A) and then, slightly hammered around its top surface by a hammer (C) or a hollow bar (or a copper rod) with a diameter slightly smaller than that of the outer shell of the bearing (B) to keep it evenly pushed in the shaft opening (A). But, actually, the bearing (B) is always not maintained flatly while being hammered because of unbalanced force, apt to damage the inner wall of the shaft opening (A) to downgrade the sealed condition of the bearing (B), making noise and easily damaging a machine while operating.

### SUMMARY OF THE INVENTION

The objective of this invention is to offer an air tool with a function of buffer and convenience of replacing a striking device.

The main characteristics of the invention are a main rod, a sleeve, a compression spring and a connector. The main rod possesses a plugging bar at its one end portion, a blocking annular surface located in its intermediate portion, and a through bar extended downward from the blocking annular surface. The through bar is provided with a connecting portion 120 female-threaded in its end portion. The sleeve is mounted around the main rod, provided with a passage formed inside it and a blocking flange formed inside and near its end. The compression spring is mounted around the through bar of the main rod and confined in the passage of the sleeve, with one end leaning on the blocking annular surface of the main rod and the other end leaning on the blocking flange of the sleeve. The connector screwed with the end of the main rod is provided with a threaded bar, a leaning surface and a threaded hole formed in its rear portion.

### BRIEF DESCRIPTION OF DRAWINGS

This invention is better understood by referring to the accompanying drawings, wherein:

FIG. 1 is a cross-sectional view of a conventional air tool;

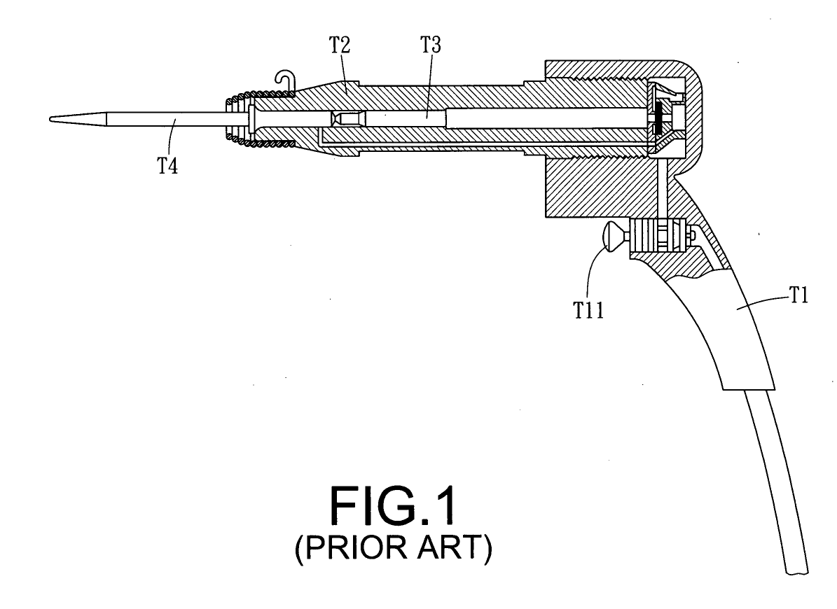

FIG. 2 is a perspective view of a bearing in the conventional air tool, showing it being assembled;

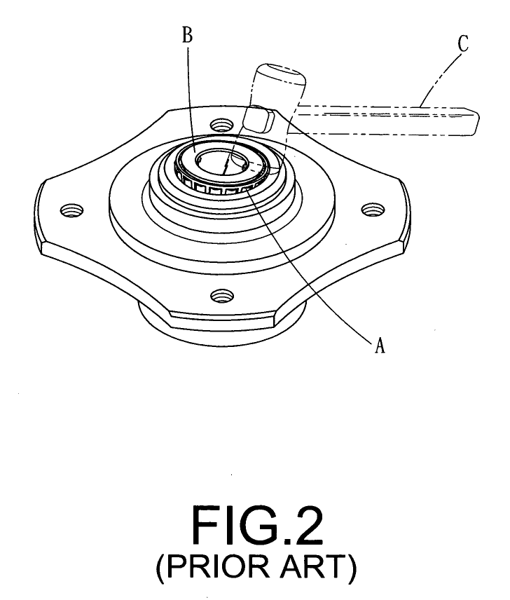

FIG. 3 is an exploded perspective view of a preferred embodiment of an air tool in the present invention;

FIG. 4 is a cross-sectional view of the preferred embodiment of an air tool in the present invention;

FIG. 5 is a perspective view of the preferred embodiment of an air tool in the present invention, showing it being operated;

FIG. 6 is a cross-sectional view of the preferred embodiment of an air tool in the present invention, showing it being operated; and

FIG. 7 is a perspective view of the preferred embodiment of an air tool in the present invention, showing it being assembled with another striking device.

### DETAILED DESCRIPTION OF THE PREFERRED EMBODIMENT

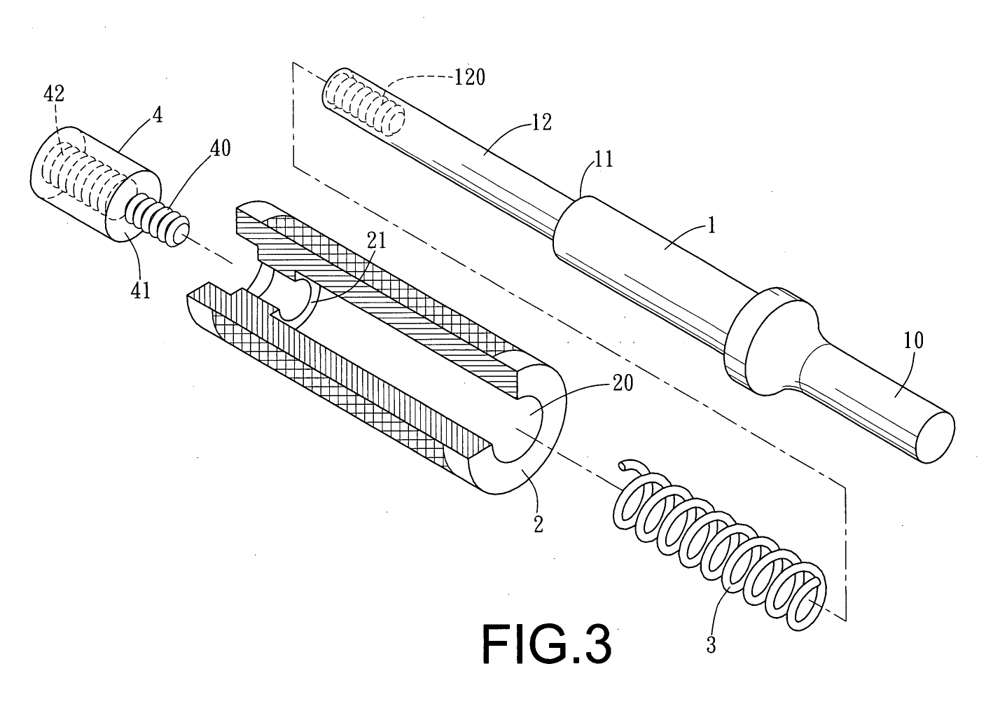

As shown in FIGS. 3˜5, a preferred embodiment of an air tool in the present invention is composed of a main rod 1, a sleeve 2, a compression spring 3 and a connector 4.

The main rod 1 is provided with a plugging bar 10 formed at its one end, a blocking annular surface 11 located in its intermediate portion, and a through bar 12 extended downward from the blocking annular surface 11 with a smaller diameter than that of the plugging bar 10. The through bar 12 is provided with a connecting portion 120 female-threaded in its end section.

The sleeve 2 is mounted around the main rod 1, provided with a passage 20 formed inside it and a blocking annular surface 21 formed inside and near its end.

The compression spring 3 is mounted around the through bar 12 of the main rod 1 and confined in the passage 20 of the sleeve 2, with one end leaning on the blocking annular surface 11 of the main rod 1 and the other end leaning on the blocking annular surface 21 of the sleeve 2.

The connector 4 is screwed in the end of the main rod 1, provided with a screw bar 40, a leaning annular surface 41 planted with the male-threaded bar 40 for the blocking annular surface 21 of the sleeve 2 to rest against, and a threaded hole 42 formed in its rear portion.

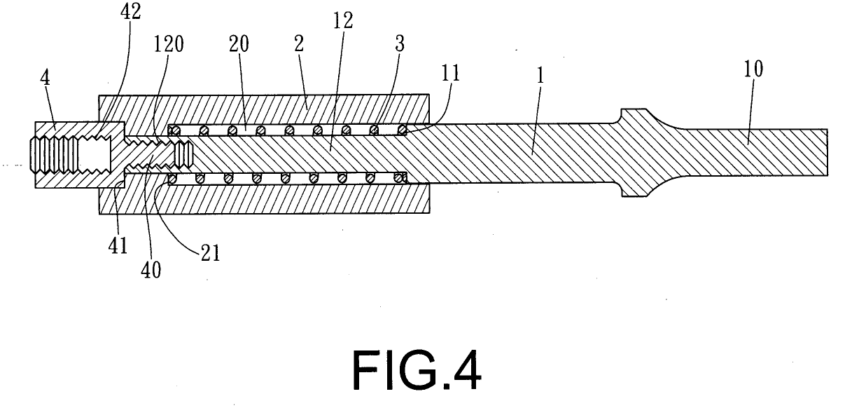

In assembly, as shown in FIGS. 3 and 4, the compression spring 3 is first mounted around the through bar 12 of the main rod 1 and then, inserted in the passage 20 of the sleeve 2. Next, the male-threaded bar 40 of the connector 4 is engaged with the connecting portion 120 of the main rod 1 to keep the leaning annular surface 41 of the connector 4 resting on the blocking annular surface 21 of the sleeve 2.

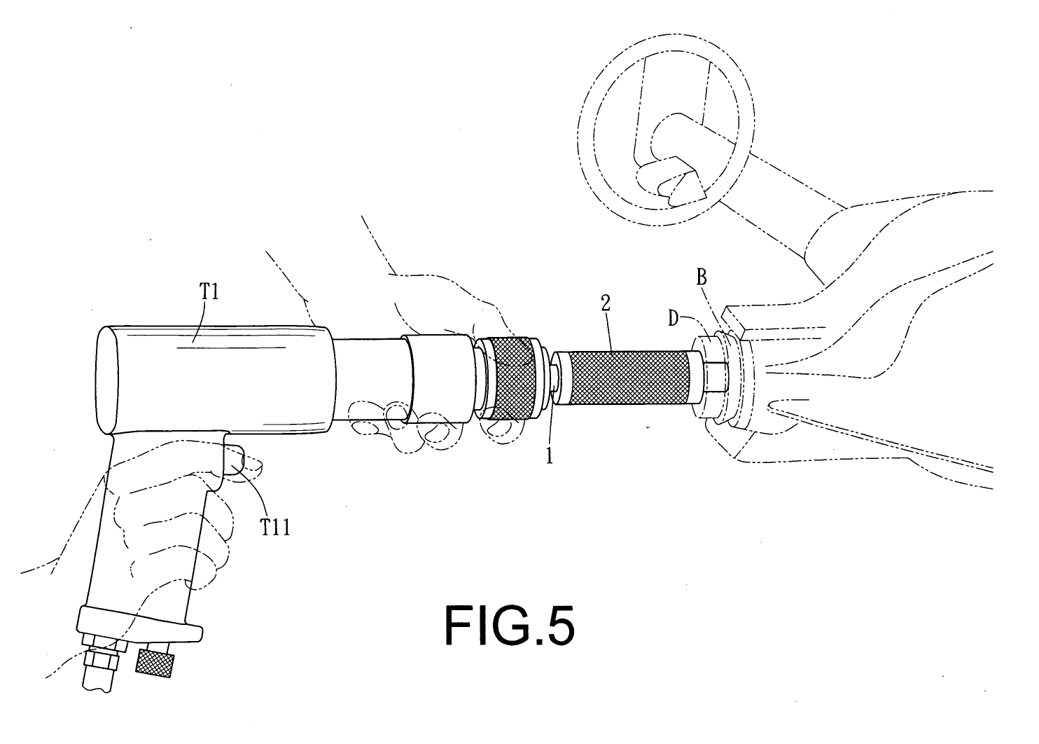

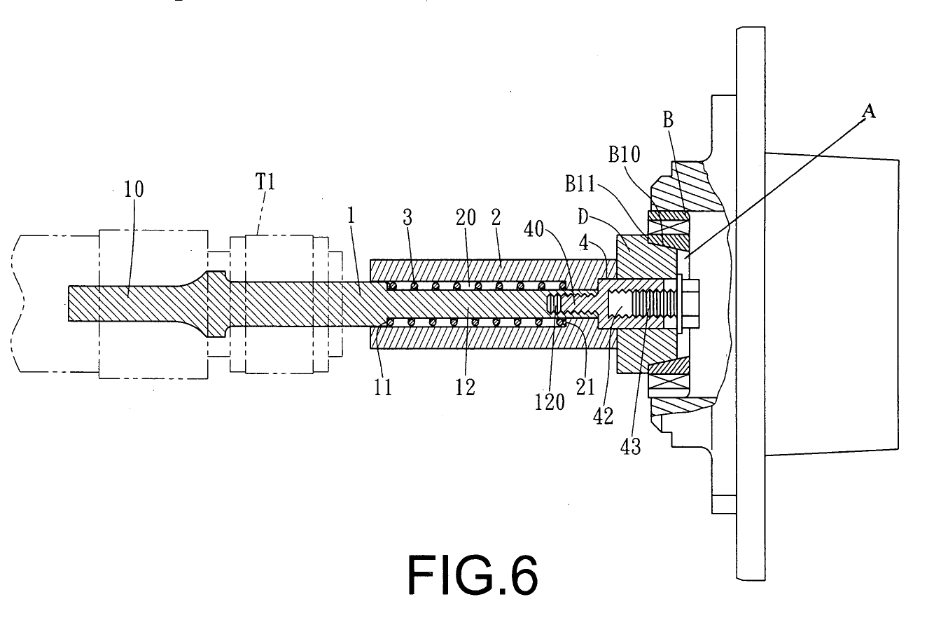

Next, as shown in FIGS. 5 and 6, according to the diameter of a bearing (B) to be installed in a machine, a proper positioning block (D) is selected and fitted and screwed with the connector 4. The plugging bar 10 of the main rod 1 is then inserted in an air tool (T) that, by the time, is held by a user to keep the positioning block (D) attached with an inner-diameter wall (B10) and also pressing a top annular edge (B11) of the bearing (B). Next, via pressing a button (T11) with a forefinger, the bearing (B) can be pushed forward to be evenly and quickly positioned in the shaft opening (A) by the positioning block (D). In addition, the elastic counterforce of the compression spring 4 generated after being compressed can elastically resist the force of the main rod 1 to weaken the impact, enabling the bearing (B) to be installed smoothly.

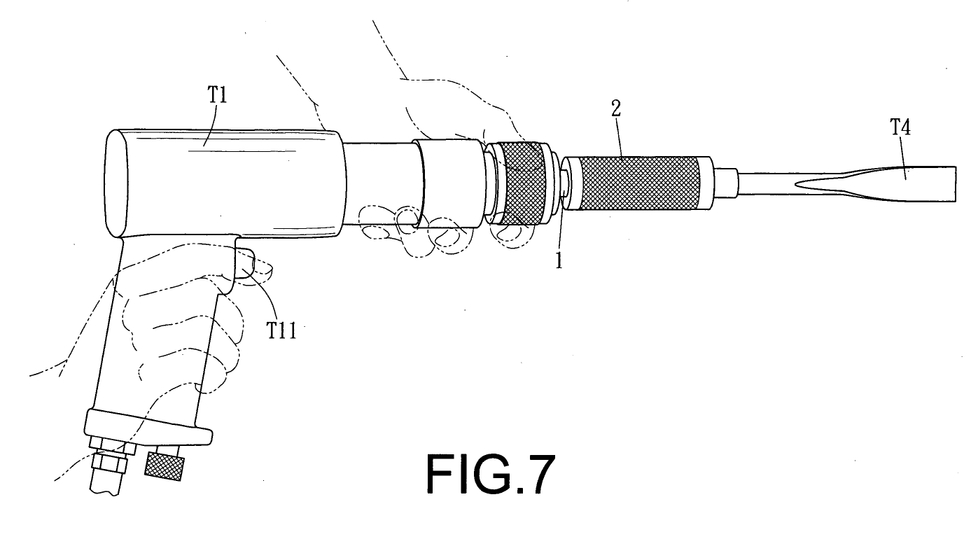

As shown in FIG. 7, the present invention can be conveniently assembled with another striking device (T4), such as a chisel or a striking block etc., to carry out diverse works.

While the preferred embodiment of the invention has been described above, it will be recognized and understood that various modifications may be made therein and the appended claims are intended to cover all such modifications that may fall within the spirit and scope of the invention.

1. (canceled)

2. an air tool in the present invention is composed of a main rod, a sleeve, a compression spring and a connector, wherein
the main rod is provided with a plugging bar formed at its one end, a blocking annular surface located in an intermediate portion thereof, and a through bar extended downward from the blocking annular surface with a smaller diameter than that of the blocking annular surface; the through bar is provided with a connecting portion female-threaded in one end section thereof; one end of the plugging bar has an enlarged ring with an diameter greater than that of the blocking annular surface; and two ends surfaces of the plugging bar are round surfaces;
the sleeve is mounted around the main rod, and provided with a passage formed therein and a blocking annular ring protruding out near a distal end of the passage, two sides of the blocking annular ring is formed as tow resisting sides;
the compression spring is mounted around the through bar of the main rod and confined in the passage of the sleeve, with one end leaning on one side of the blocking annular surface of the main rod and the other end leaning on the blocking annular ring of the sleeve.
the connector is screwed in the end of the main rod, provided with a screw bar, a leaning annular surface planted with the male-threaded bar for the blocking annular surface of the sleeve to rest against, and a threaded hole formed in its rear portion for connecting an external driving object; and
wherein in assembly state, the compression spring is first mounted around the through bar of the main rod and then, inserted in the passage of the sleeve, while the plugging bar and the enlarged ring thereof is at an outer side of the sleeve; next, the male-threaded bar of the connector is engaged with the connecting portion of the main rod to keep the leaning annular surface of the connector resting on one side of the blocking annular ring of the sleeve.
